(19) United States
(12) Patent Application Publication
(10) Pub. No.: US 2010/0251785 A1
(43) Pub. Date: Oct. 7, 2010

(54) SYSTEM AND METHOD FOR CONTAINER SECURITY

(75) Inventor: Mahmood Zarei, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/416,542

(22) Filed: Apr. 1, 2009

(51) Int. Cl. E05B 65/14; B65G 47/00; G06F 7/00; E05B 65/00; G05B 19/00; B65D 90/00

(52) U.S. Cl. 70/58; 414/800; 700/226; 70/264; 70/57.1; 340/5.6; 455/344; 340/5.7; 220/1.5

(57) ABSTRACT

A shipping container includes internal computer-operated locks that cannot be accessed from outside the container. A satellite receiver inside the container can receive position signals and other commands from a satellite to unlock the locks.

### I. FIELD OF THE INVENTION

The present invention relates generally to container security.

### II. BACKGROUND OF THE INVENTION

Pilfering from shipping containers is a continuing problem. Systems have been devised to counter pilfering but the systems either tend to be too weak, e.g., lock systems that can be cut or otherwise circumvented by thieves, or too strong.

An example of the latter is disclosed in USPP 2003/0179073, which teaches a container with locks that can be opened only at a destination location by an external portable destination computer which transmits into the container locking system the geographic location of the destination. The locks are opened only if the geographic location transmitted into the container by the destination computer matches a preprogammed destination in the container locking system. As understood herein, such a system would prevent otherwise legitimate unlockings by, e.g., border security or mobile traffic police, who might wish to inspect the container contents at locations that are not only different from the preprogrammed destination but also potentially unpredictable in advance. Because the destination computer would not be available under such circumstances, the container cannot be unlocked for such unforeseen yet otherwise legitimate reasons.

### SUMMARY OF THE INVENTION

Accordingly, a shipping container includes a container body defining an interior and a door movable between a closed configuration, in which the interior cannot be accessed from outside the container body, and an open configuration, in which the interior can be accessed from outside the container body. One or more computer-controlled locks are coupled to the door and are movable between an unlocked configuration, in which the door can moved to the open configuration, and a locked configuration, in which the door is held in the closed configuration. The locks are disposed entirely within the interior such that the locks cannot be accessed from outside the container body when the door is in the closed configuration. A wireless receiver is in the interior as is a processor communicating with the wireless receiver and the lock to control the lock responsive to signals from wireless receiver.

In some example a card reader may be disposed adjacent a bottom of the container body and configured to detect a portable security card when the card is near the card reader. To this end, the card reader communicates with the processor. The card reader can generate a signal to cause the processor to control the lock when an authorized security card is detected by the card reader. The card reader maybe disposed substantially on a longitudinal centerline of the container.

In example embodiments a battery may power the processor and locks. A solar collector can be mounted on the container and connected to the battery to provide charge to the battery. The battery may also or alternatively be connected to a transport platform such as a tractor which bears the container, to receive charge from the transport platform.

In some implementations a visual display may be mounted on an exterior surface of the body in communication with the processor to present a digital seal code observable by a person. The wireless receiver may be a satellite receiver. Additionally, a position receiver can be provided in the interior of the container to receive position signals. The processor can periodically cause the position of the container as indicated by the position receiver to be transmitted to a control center.

In another aspect, a method includes loading a container and communicating with a control center that the container is ready to lock. The method also includes sending a wireless lock signal from the control center to the container, with the container automatically locking itself in response to the lock signal. A first digital seal code is associated with the locking. The container automatically unlocks itself at a destination in response to a position signal received by a satellite receiver inside the container.

In another aspect, a control center computer executes logic that includes receiving information that a container is ready to be locked, causing a first lock signal to be wirelessly transmitted to the container, and causing a first digital seal code to be associated with locking the container pursuant to the first lock signal. The logic also includes causing an unlock signal to be wirelessly transmitted to the container when, for example, the container is “red-lighted” by security personnel such as at a border crossing. After inspection the logic includes causing a second lock signal to be wirelessly transmitted to the container and causing a second digital seal code to be associated with locking the container pursuant to the second lock signal.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of an example container in the closed configuration;

FIG. 2 is a perspective view of an example container in the open configuration, showing internal components schematically;

FIG. 3 is a bottom plan view of an example container;

FIG. 4 is a flow chart showing example lock logic;

FIG. 5 is a flow chart showing example tracking logic;

FIG. 6 is a flow chart showing example unlock logic; and

FIG. 7 is a perspective view of another example container in the open configuration.

### DETAILED DESCRIPTION OF THE PREFERRED EMBODIMENT

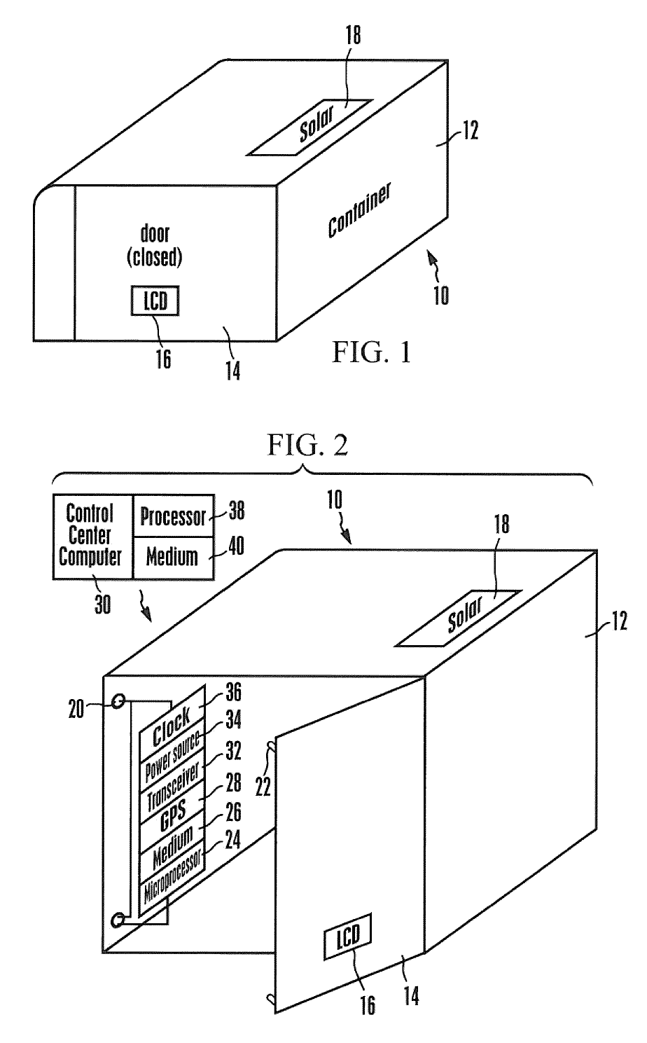

Referring initially to FIGS. 1 and 2, a container 10 includes a hollow body 12 that may be parallelepiped-shaped as shown and a door 14. The door 14 is movable between a closed configuration. (FIG. 1), in which the interior of the container cannot be accessed by a person from outside the container body, and an open configuration (FIG. 2), in which the interior can be accessed from outside the container body.

In some embodiments a computer-controlled display 16 may be mounted on an external surface of the container such as on the door 14 as shown. The display 16, which may be, without limitation, a liquid crystal display (LCD) or light emitting diode (LED) display, is caused to present human-readable alpha-numeric information in accordance with disclosure below. Also, a solar collector 18 can be mounted on the container body for purposes to be shortly disclosed.

As shown best in FIG. 2, one or more computer-controlled locks 20 are coupled to the door 14. The locks 20 are disposed entirely within the interior of the body 12 such that the locks cannot be accessed from outside the container body 12 when the door 14 is in the closed configuration. The locks, which may include, e.g., solenoid-operated plungers that engage (when locked) and disengage (when unlocked) corresponding receptacles 22 on the door 14, are movable between an unlocked configuration, in which the door 14 can moved from the closed to the open configuration, and a locked configuration, in which the door 14 is held in the closed configuration shown in FIG. 2.

The locks 20 are controlled by a processor 24 within the interior of the body 12. It is to be understood that the processor 24 and other components are shown on a vertical wall inside the container body, the location of the components within the container body is not limiting, e.g., the components might be mounted on the inside surface of the door 14.

The processor 24 may access a computer-readable storage medium 26 bearing instructions to cause the processor 24 to execute certain logic herein. The processor 24 may receive geographic position information from a position receiver 28 such as a global positioning satellite (GPS) receiver. Also, the processor 24 may exchange information with a control center computer 30 using a wireless transceiver 32 within the container body 12. Without limitation, the transceiver 32 may be a satellite communications transceiver. A power supply 34 such as one or more rechargeable batteries may power the locks 20 and other components within the container body 12 and to that end may receive charge current from the solar collector 18. A digital clock 36 may also be provided in the container body 12 to provide time information to the processor 24.

The control center computer 30 also executes certain logic described below. To that end, the control center computer 30 includes a CC processor 38 accessing logic on a computer readable storage medium 40.

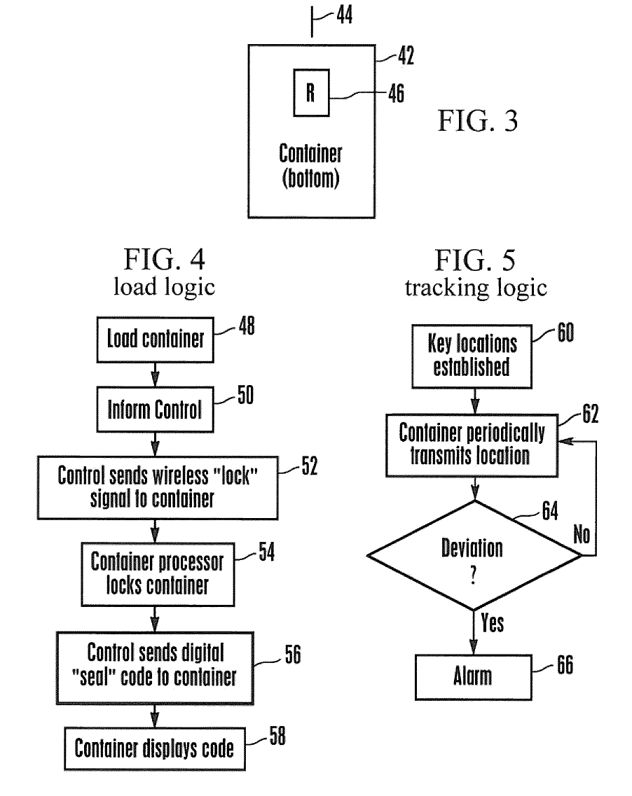

Referring briefly to FIG. 3, a bottom 42 of the container body 12 may define a longitudinal centerline 44 of the container 10, and a card reader 46 can be disposed on the outside or inside surface of the bottom 42 substantially along the centerline in some embodiments. The card reader 46 communicates with the processor 24 inside the container. The reader 46 can detect a portable security card when the card is near the card reader and if the security card successfully authenticates, the processor receives an unlock signal from the card reader to move the locks 20 to the unlock configuration.

As understood herein, containers often are transported by rail stacked one on another. The bottom container is not easily accessible to thieves, being protected on its bottom by the rail car and on its top by the container above, but the top container is more exposed. By placing the card reader 46 on the bottom of the container, the card reader is shielded from thieves while being transported by rail, yet can still be opened by an authorized security card when the container arrives at an authorized destination having equipment that can lift the container from the train.

Example container load logic is shown in FIG. 4. At block 48 the container is loaded and then at block 50, the control center computer 30 is so informed. Moving to block 52, the control center computer 30 causes a wireless lock signal to be sent to the container 10, which receives the lock signal at the wireless transceiver 32, providing the lock signal to the processor 24 inside the container. The container automatically locks at block 54 itself in response to the lock signal. Specifically, with the door 14 closed the container processor 24 commands the locks 20 to assume their lock configuration.

Additionally, at block 56 a digital seal code is associated with the locking of the container 10. The code may be retained and recorded at the control center computer 30 and in some embodiments the code may also be wirelessly transmitted to the container processor 24. The container processor 24 can cause the code to be displayed on the display 16 at block 58, so that lading personnel can visually confirm the code and record the code on relevant shipping documents that typically are conveyed with the container 10.

FIG. 5 shows that when in transit, tracking logic may be employed to enhance the security of the container 10. At block 60, key locations are established and recorded at, e.g., the control center computer 30. For example, the intended destination typically is recorded for purposes to be shortly disclosed. Also, “safe haven” locations may be identified at which the container may be unlocked. Further, expected waypoints may be recorded, along with times at which the container is expected to arrive at the waypoints.

Proceeding to block 62, the container processor 24, which receives position information from the position receiver 28 and timing information from the clock 36, periodically causes the transceiver 32 to transmit to the control center the geographic location of the container 10. If a deviation from an expected location and time of arrival exceeding a threshold is detected at decision diamond 64, an alarm may be activated at block 66. Without limitation, alarms at the control center as well as on the container itself may be activated at block 66. In some embodiments, a signal may be automatically transmitted to law enforcement personnel in the event of a detected deviation. The alarm signal may also be used to disable the transport platform carrying the container, e.g., if the platform is a trailer the alarm signal could cause a disabling unit in the tractor to prevent turning the tractor motor on after it is turned off, until such time as the disabling unit is reset.

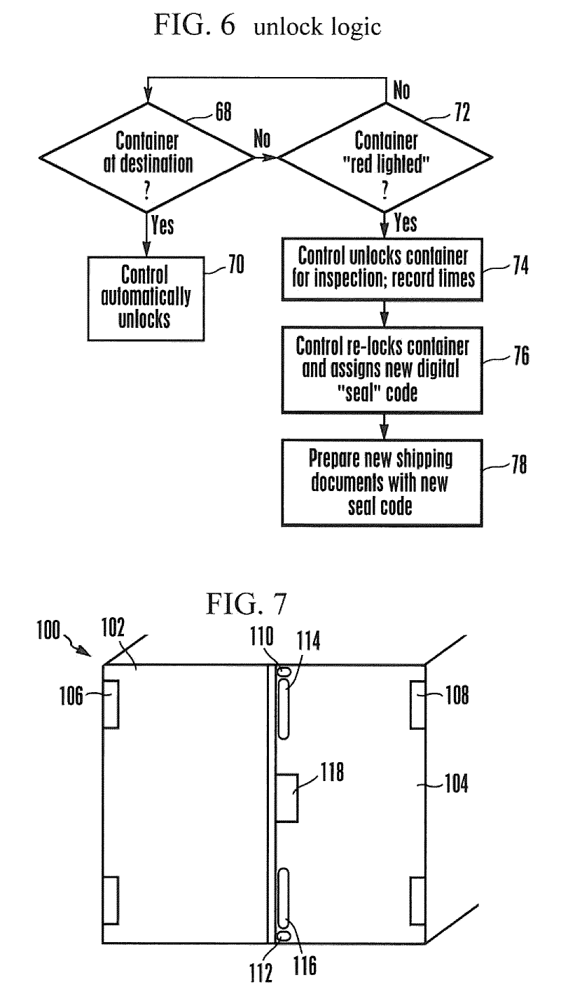

FIG. 6 shows example unlock logic that maybe employed. When it is determined at decision diamond 68 that the container 10 has reached its intended destination as indicated by a position signal received by the container position receiver 28 and sent to the control center computer 30 by the transceiver 32, the container is automatically unlocked at block 70. In one implementation the control center computer 30 sends an unlock signal to the container processor 24 to cause the processor 24 to automatically move the locks 20 to the unlock configuration. In another implementation the control center computer 30 can provide the destination location to the container during, e.g., loading, and the destination location maybe stored on the container computer readable medium 26. In such an embodiment, the container processor 24 automatically unlocks the container when the position from the receiver 28 matches the locally stored destination location, without requiring control center command or other command to do so.

Present principles also envision the possibility that the container 10 may need to be opened during transit for expected or unexpected inspections by security personnel, e.g., by law enforcement personnel, border control personnel, etc. Such a security stop is colloquially referred to as being “red lighted”, i.e., stopped for legitimate reasons for inspection, and if such an event occurs at decision diamond 72, the container transporter typically contacts the control center to request unlocking. At block 74, the control center computer 30 wirelessly transmits to the container 10 an unlock signal. The times during which the door 14 is unlocked by the container processor 24 in response to the unlock command may be recorded by the control center computer 30.

Upon completion of the inspection, the control center is notified and at block 76 the control center computer transmits a lock signal to the container processor 24. Also, a new digital seal code is associated with the relocking, and in accordance with principles above the new code may be sent to the container 10 for presentation on the display 16. The container transporter may record this code on new shipping documents at block 78.

FIG. 7 shows an alternate container 100 that is in all essential respects identical in operation and configuration to the container shown in FIGS. 1 and 2, with the following exceptions. As shown, the container 100 in FIG. 7 is of the double door type, meaning that two doors 102, 104 are hinged at or near the sides of the container and meet along the centerline of the container, with, e.g., the door 104 holding the door 102 closed so that only the door 104 need be locked.

In the example shown, the door 102 is hinged at a hinge 106 and the door 104 is hinged at a hinge 108. The hinges 106, 108 advantageously may be interior to the container so that when the doors are closed, the hinges are not accessible from outside the container.

A non-limiting example locking system is shown in FIG. 7. Specifically, upper and lower solenoid receptacles 110, 112 such as but not limited to horizontally-oriented metal rings can be engaged with the interior of the container 100. Upper and lower vertically reciprocable solenoid-operated rods 114, 116 can be mounted on the door 104 and can engage and disengage the receptacles 110, 112 respectively under control of a processor inside the container in accordance with principles above to lock and unlock the door 104 (and hence the door 102) shut.

If desired, the rods 114, 116 may be juxtaposed with a sensor 118 such as but not limited to Hall sensor. The sensor is connected to the processor. The sensor can generate a signal indicating “unsuccessful lock” when, in the presence of a “lock” signal from the processor, one or both rods 116, 118 fail to move sufficiently in the lock direction. This signal may be sent by the processor back to the control center for corrective action.

While the particular SYSTEM AND METHOD FOR CONTAINER SECURITY is herein shown and described in detail, it is to be understood that the subject matter which is encompassed by the present invention is limited only by the claims.

What is claimed is:

1. A shipping container comprising:
a container body defining an interior and a door movable between a closed configuration, in which the interior cannot be accessed from outside the container body, and an open configuration, in which the interior can be accessed from outside the container body;
at least one computer-controlled lock coupled to the door and movable between an unlocked configuration, in which the door can moved to the open configuration, and a locked configuration, in which the door is held in the closed configuration, the lock being disposed entirely within the interior such that the lock cannot be accessed from outside the container body when the door is in the closed configuration;
at least one wireless receiver in the interior; and
at least one processor in the interior and communicating with the wireless receiver and the lock to control the lock responsive to signals from wireless receiver.

2. The container of claim 1, comprising a card reader disposed adjacent a bottom of the container body and configured to detect a portable security card when the card is near the card reader, the card reader communicating with the processor.

3. The container of claim 2, wherein the card reader generates a signal to cause the processor to control the lock when an authorized security card is detected by the card reader.

4. The container of claim 3, wherein the card reader is disposed substantially on a longitudinal centerline of the container.

5. The container of claim 1, further comprising a battery powering the processor and lock and a solar collector mounted on the container and connected to the battery to provide charge to the battery.

6. The container of claim 1, further comprising a visual display mounted on an exterior surface of the body and communicating with the processor to present a digital seal code observable by a person.

7. The container of claim 1, wherein the wireless receiver is a satellite receiver.

8. The container of claim 1, further comprising a position receiver in the interior of the container and receiving position signals, the processor periodically causing position of the container as indicated by the position receiver to be transmitted to a control center.

9. A method comprising:
loading a container;
communicating with a control center that the container is ready to lock;
sending a wireless lock signal from the control center to the container;
the container automatically locking itself in response to the lock signal, a first digital seal code being associated with the locking act; and
the container automatically unlocking itself at a destination in response to a position signal received by a satellite receiver inside the container.

10. The method of claim 9, wherein locks locking the container are entirely interior to the container.

11. The method of claim 9, wherein the container bears an externally visible computer-controlled display presenting the seal code.

12. The method of claim 9, wherein the container unlocks itself in response to a signal from a card reader located on a bottom of the container.

13. The method of claim 9, wherein in response to a request by authorized security personnel to open the container for inspection, the method includes:
sending the request to the control center;
the control center wirelessly transmitting to the container an unlock signal and a second digital seal code different from the first digital seal code;
the container automatically unlocking itself in response to receiving the unlock signal.

14. The method of claim 13, further comprising replacing the first seal code with the second seal code on computer-controlled display mounted on an external surface of the container.

15. Control center computer executing logic on a computer readable medium, the logic comprising:
receiving information that a container is ready to be locked;
causing a first lock signal to be wirelessly transmitted to the container;
causing a first digital seal code to be associated with locking the container pursuant to the first lock signal;
causing an unlock signal to be wirelessly transmitted to the container;
causing a second lock signal to be wirelessly transmitted to the container; and
causing a second digital seal code to be associated with locking the container pursuant to the second lock signal.

16. The computer of claim 16, wherein the computer causes a destination location to be wirelessly transmitted to the container and does not cause an unlock signal to be sent to the container when the container arrives at the destination location, the container automatically unlocking itself at the destination location.

17. The computer of claim 16, wherein the unlock signal is caused to be transmitted to the container in response to a request by authorized security personnel to open the container for inspection.

18. The computer of claim 16, wherein the computer receives periodic position information from the container and generates an alarm when a container position is beyond a threshold of an expected position.

19. The computer of claim 16, wherein the container is unlocked by a card reader on the container and the computer receives information pertaining thereto.

20. The computer of claim 16, wherein the lock and unlock signals are sent to the container through a satellite link.
